(19) United States
(12) Patent Application Publication
(10) Pub. No.: US 2024/0406177 A1
(43) Pub. Date: Dec. 5, 2024

(54) AUTOMATED AND INTELLIGENT REVIEW OF ACCESS DECISIONS RESPONSIVE TO DATA-ENVIRONMENT ACCESS REQUESTS

(71) Applicant: Veza Technologies, Inc., Los Gatos, CA (US)

(72) Inventors: Maohua Lu, Fremont, CA (US); Tarun Thakur, Los Gatos, CA (US); Robert Whitcher, Erie, CO (US)

(21) Appl. No.: 18/732,058

(22) Filed: Jun. 3, 2024

Related U.S. Application Data
(60) Provisional application No. 63/505,763, filed on Jun. 2, 2023.

(51) Int. Cl. H04L 9/40

(52) U.S. Cl. CPC H04L 63/101; H04L 63/105; H04L 63/20

(57) ABSTRACT

The technology disclosed herein enables automated approval and denial of access decisions responsive to access requests to data environments. In a particular example, a method provides obtaining access decisions responsive to access requests to a plurality of data environments. The method provides determining, based on baseline rules, a subset of the access decisions that should be rejected. The method further provides receiving user input indicating additional ones of the access decisions for inclusion in the subset and determining a new access-review rule based on the user input.

### RELATED APPLICATIONS

This application is related to and claims priority to U.S. Provisional Patent Application 63/505,763, titled “AUTOMATED AND INTELLIGENT REVIEW OF ACCESS DECISIONS RESPONSIVE TO DATA-ENVIRONMENT ACCESS REQUESTS,” filed Jun. 2, 2023, and which is hereby incorporated by reference in its entirety.

### TECHNICAL BACKGROUND

Modern enterprises use numerous data environments to store, manage, and/or process data and those environments may be managed by different systems, applications, and/or platforms from different providers, and each may use its own data repository (e.g., database). For instance, different departments may employ different database systems depending on the features offered by the respective system (e.g., accounting may use a first database system while human resources uses a second). In some cases, a single department may itself use multiple platforms for data repositories depending on the capabilities of each platform even if the platforms manage similar data sets. For example, human resources may use one platform to onboard and terminate employees from the enterprise while another platform is used to handle employees' compensation and benefits. Given the large number of users and resources of the data environments to which the users may have access, it can be difficult to ensure the resources are only being accessed by proper ones of the users. As such, entities often require access reviews in which one or more users review access decisions to determine whether the access decisions were made as desired by the entity (e.g., ensure a user that the entity would not want to access a resource was denied access to the resource). The access review process can be tedious and error prone depending on the number of access requests being reviewed.

### SUMMARY

The technology disclosed herein enables automated approval and denial of access decisions responsive to access requests to data environments. In a particular example, a method provides obtaining access decisions responsive to access requests to a plurality of data environments. The method provides determining, based on baseline rules, a subset of the access decisions that should be rejected. The method further provides receiving user input indicating additional ones of the access requests for inclusion in the subset and determining a new access-review rule based on the user input.

In another example, an apparatus is provided having one or more computer readable storage media and a processing system operatively coupled with the one or more computer readable storage media. Program instructions stored on the one or more computer readable storage media, when read and executed by the processing system, direct the apparatus to perform the steps of the above-recited method.

### BRIEF DESCRIPTION OF THE DRAWINGS

FIG. 1 illustrates an implementation for automating access review for access decisions responsive to access requests to data environments.

FIG. 2 illustrates an operation to automate access review for access decisions responsive to access requests to data environments.

FIG. 3 illustrates an operation for automating access review for access decisions responsive to access requests to data environments.

FIG. 4 illustrates an operation to automate access review for access decisions responsive to access requests to data environments.

FIG. 5 illustrates an operation to automate access review for access decisions responsive to access requests to data environments.

FIG. 6 illustrates an operation to automate access review for access decisions responsive to access requests to data environments.

FIG. 7 illustrates an operation to automate access review for access decisions responsive to access requests to data environments.

FIG. 8 illustrates a computing architecture for automating access review for access decisions responsive to access requests to data environments.

### DETAILED DESCRIPTION

The access review systems disclosed below automate access review to improve accuracy of the access review and take the review load off of human users. An access review system obtains access decisions and uses baseline rules for determining whether each access decision should be rejected. Rejected decisions are decisions that were not made correctly in accordance with the baseline rules. Rejected decisions may indicate that an access rule should be created to prevent the denied access decision from occurring again in the future. For example, a rejected access decision may indicate a user was denied access to a resource. A new access rule may be created to allow the user the access the resource in the future, which would satisfy the baseline rules. A human user can also review the access decisions and indicate further access decisions that should be rejected. The access review system may identify patterns in the user's review to determine whether additional access-review rules should be created to automatically reject access decisions similar to those rejected by the user in future access reviews.

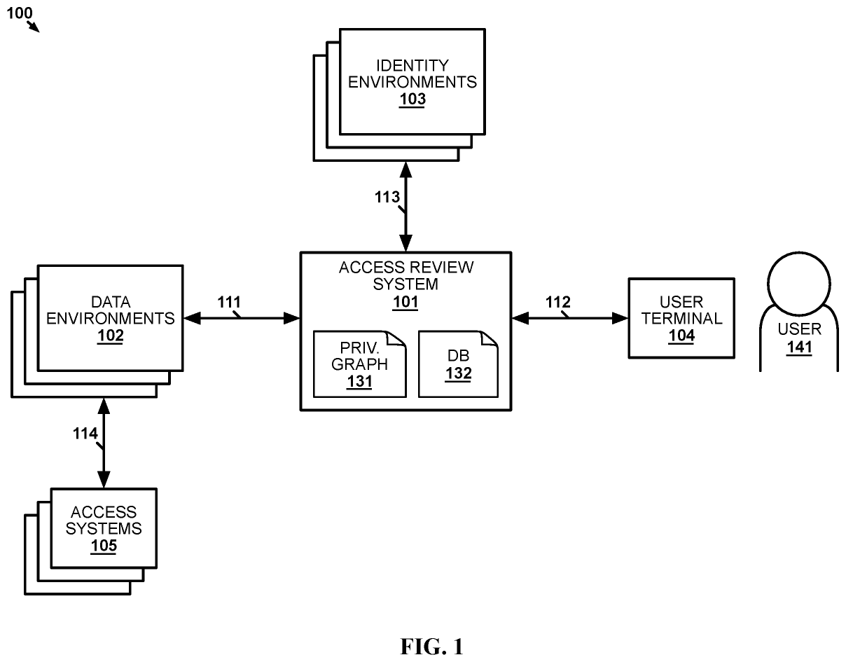

FIG. 1 illustrates implementation 100 for automating access review for access decisions responsive to access requests to data environments. Implementation 100 includes access review system 101, data environments 102, identity environments 103, user terminal 104, and access systems 105. Access review system 101 and data environments 102 communicate over respective communication links 111. Access review system 101 and user terminal 104 communicate over communication link 112. Access review system 101 and access systems 105 communicate over communication links 114. Access review system 101 and identity environments 103 communicate over respective communication links 113. While communication links 111-114 are shown as direct links, communication links 111-113 may include intervening systems, networks, and/or devices. Access review system 101 executes on one or more computing systems, such as server systems, having processing and communication circuitry to operate as described below. User terminal 104 is a user operated computing system, such as a desktop workstation, laptop, tablet computer, smartphone, etc. Access systems 105 may include user operated computing systems, unmanned servers, or any other type of computing system that may access resources provided by data environments 102—including combinations thereof. Similarly, while human users are described herein as accessing the resources (i.e., via their respective user terminals) in the examples herein, users accessing data environments 102 may include non-human users, such as systems, applications, micro-services, etc., or some combination thereof

In operation, access review system 101 performs operation 200 to automatically reject access decisions made in response to access requests from access systems 105 to data environments 102. Data environments 102 include one or more systems that host databases, such as databases for Online Transaction Processing (OLTP) and Online Analytical Processing (OLAP), tables, files, applications, or other computing resources provided to access systems 105—including combinations thereof. Identity environments 103 include one or more systems that maintain information about users (e.g., user identity information, user attributes, etc.) and information about which of data environments 102 (including specific data/features therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access particular resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user's job title/role, a seniority of the user, a security clearance level for the user, or any other type of information that may affect which of data environments 102 the user can access. In further examples, a data environment of data environments 102 may authorize users independently.

Regardless of the arrangement between data environments 102 and identity environments 103 to determine access privileges of users, rules are implemented by the environments to define which users have access to which resources of data environments 102. The rules may indicate which users have access to which resources or may indicate which users do not have access to which resources. The rules may further indicate specific activities that a user is able, or is not able, to perform with a particular resource rather than a blanket allowance or denial of access. For example, a rule may indicate whether a user is allowed data read, data write, metadata read, metadata write, and non-data access-including combinations thereof. Access review system 101 automatically reviews access decisions made based on the rules in response to requests from access systems 105 to access resources provided by data environments 102. The access review by access review system 101 finds access decisions that do not comply with access-review rules and rejects those decisions during the access review. The access rules used to regulate access to data environments 102 may then be modified (e.g., rules may be added, deleted, or amended) to ensure a rejected access decision does not occur again. Access review system 101 performing the access review takes the load off of user 141, who is a human reviewer in this example. Access review system 101 should have improved accuracy when rejecting access decisions because user 141 may not have the capacity to remember all desirable access combinations. Likewise, the reviewing load may be heavy depending on the number of access requests being reviewed.

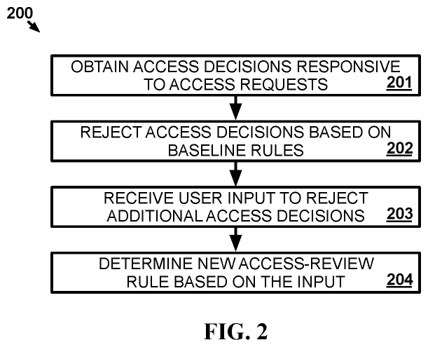

FIG. 2 illustrates operation 200 to automate access review for access decisions responsive to access requests to data environments. In operation 200, access review system 101 obtains access decisions responsive to access requests to a plurality of data environments (step 201). Access review system 101 may obtain the access decisions by requesting the access decisions from data environments 102 and/or identity environments 103. The access decisions may be requested when the time comes for an access review (e.g., an access review may be performed once per month) or may be requested periodically between access reviews. In some examples, access review system 101 may constantly monitor access decisions and track the access decisions itself (e.g., may access data environments 102 and/or identity environments 103 to record access decisions as they happen). The access decisions may be stored in database 132 in association with the time in which each respective decision occurred. Access review system 101 may only obtain the access decisions made since a previous access review. Presumably, access review system 101 will keep access decisions from previous access reviews stored in database 132 as long as those decisions may be useful (e.g., to track access decisions over time).

Access review system 101 determines, based on baseline rules, a subset of the access decisions that should be rejected (step 202). The baseline rules may include rules determined from privilege graph 131. Privilege graph 131 is a graph that connects nodes representing users to resources of data environments 102. Intervening attribute nodes of privilege graph 131 between the users and the resources indicate attributes of the users connected to the attribute nodes. Privilege graph 131, therefore, indicates which users should have access to which resources of data environments 102. However, the access rules actually implemented with respect to data environments 102 and identity environments 103 do not necessarily reflect the authorizations provided in privilege graph 131. Thus, it is possible that an access request is allowed or denied contrary to what privilege graph 131 indicates should happen. During access review, access review system 101 may identify and reject access requests that do not comply with the information in privilege graph 131. For example, privilege graph 131 may indicate a particular user does not have access to a particular resource. If an access decision indicates that the user was allowed to access the resource, then access review system 101 will reject that access decision. The baseline rules may further include access-review rules generated during previous access review iterations by access review system 101 (e.g., as described in the step below).

As part of the access review, access review system 101 receives user input indicating additional ones of the access requests for inclusion in the subset being rejected (step 203). The user input is received from user 141 via user terminal 104 in this example. In other examples, multiple users may be performing the access review. As noted above, there may be a large number of access decisions that need to be reviewed and multiple users may be assigned to perform the access review. Thus, the user input may be received from multiple users. Access review system 101 may send the user terminals of the respective users a list of access decisions that the users are tasked with reviewing. Each row of the list may indicate attributes of the access decision (e.g., the user making the access request, the resource being requested, and whether the request was allowed or denied). The users can then go through the rows and indicate which access decisions the user is rejecting.

Access review system 101 determines a new access-review rule based on the user input (step 204). The new access-review rule may be included immediately in the baseline rules used during a subsequent access review or may be presented to user 141 via user terminal 104. User 141 may then approve or reject the new rule with access review system 101 only including the rule in the baseline rules upon receiving user 141′s approval. Access review system 101 may only consider the user input from the present access review or may consider the user input from one or more previous reviews as well. For example, access review system 101 may store the user input in database 132 in association with the access decisions rejected by that input. Access review system 101 can then reference a wider range of user input when determining whether the user input indicates a new access-review rule should be created. In some examples, access review system 101 may identify patterns for user input rejecting access decisions while allowing others to determine a new access-review rule that captures the pattern.

In examples where multiple users are performing the access review, after access review system 101 identifies access decisions for rejection, access review system 101 may redistribute the access decisions among the reviewing users. For instance, access review system 101 may auto-reject a large amount of the access decisions for one user while auto-rejecting a smaller amount of the access decisions for another user. The remaining access decisions for review may be redistributed among the users to balance the remaining workload.

In some examples, access review system 101 have access to different versions of privilege graph 131 as privilege graph 131 changes over time (e.g., users with a given attribute may be allowed to access a resource one week and not the next). Thus, access review system 101 may be able to determine whether an access decision was proper at the time it was made even though it is not proper at the time the access review is occurring. Also, rather than waiting till the end of a defined period to perform an access review, access review system 101 may perform the access review continually, or in smaller increments, then stitch together the results to compile results for the entire access review period (e.g., if the access review period is a month, access review system 101 may perform weekly reviews within the month and then stitch those weekly results together).

In some examples, access review system 101 (or a similarly configured access review system) may service more than one entity. If another entity has similar data environment and access system arrangements, then the access-review rule may apply to the other entity's access review as well. In that case, access review system 101 may suggest the access-review rule to the other entity for use when performing its own access reviews.

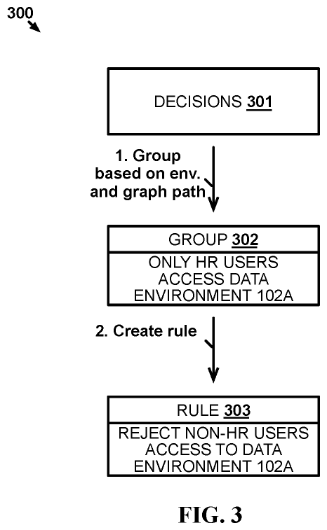

FIG. 3 illustrates operational scenario 300 for automating access review for access decisions responsive to access requests to data environments. Operational scenario 300 is an example for how access review system 101 may determine a new access-review rule. Access decisions 301 are access decisions obtained by access review system 101 in operation 200. Access review system 101 groups the access decisions at step 1 into access decisions having similar paths through privilege graph 131 and similar resources of data environments 102 being requested. More specifically, access review system 101 groups the access request based on how certain paths have access decisions get rejected while others are approved. Group 302 is an example group of the groups that access review system 101 may create.

The access decisions in group 302 are those where access review system 101 recognizes that only users on the HR team accessing data environment 102A of data environments 102 are approved access decisions for accessing data environment 102A. As such, access review system 101 creates access-review rule 303 at step 2. Access-review rule 303 is a rule that, when enforced by access review system 101 access reviews, directs access review system 101 to automatically reject access decisions that allow users outside of the HR team to access data environment 102A. Access-review rule 303 may be enforced automatically or may be suggested to user 141 for approval prior to enforcement so user 141 can confirm access review system 101 has created a desirable rule.

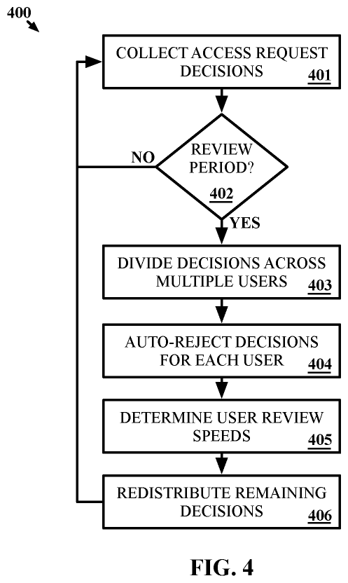

FIG. 4 illustrates operation 400 to automate access review for access decisions responsive to access requests to data environments. Operation 400 is an example of how access review system 101 may further assist human users to review access request decisions and reject those of the decisions that the users determine were made incorrectly. In a period is set for which the human users will review access request decisions that were made therein. The period may be daily, weekly, monthly, quarterly, or some other period of time. During the period, access review system 101 collects access request decisions made for access requests to data environments 102 (step 401). Access review system 101 may query data environments 102 for information about access requests from access systems 105 (e.g., indications of a source of the access request, such as a user, application, or system of access systems 105, and a resource of data environments 102 to which access is being requested) and about decisions made by data environments 102 in response to those access requests. Alternatively, data environments 102 may be configured to send the information automatically, access review system 101 may be in the path of the access requests and decision responses, or some other mechanism for obtaining the information may be used.

Access review system 101 monitors for when the period is reached (step 402). When the period is reached, access review system 101 divides the access decisions between a number of human users tasked to review the access decisions (step 403). Depending on the length of the period and the amount of access requests handled, the amount of access request decisions may be very large. As such, an entity may task multiple employees with reviewing the decisions to make the review load more manageable. To further assist the users with their task, access review system 101 uses baseline rules to auto-reject access decisions (step 404). The baseline rules may correspond to what privilege graph 131 indicates the decision should be, may include rules created based on previous decisions rejected by the human users, rules manually entered by a human user, or obtained from some other source.

After auto-rejecting decisions, the number of decisions may be uneven between the human users. Access review system 101 determines speeds at which each user reviews access decisions (step 405). Access review system 101 may allow the users to continue reviewing the access decisions in their respective sets of access decisions for an amount of time to measure the users' review speeds or may determine the review speeds from past review periods. Based on the number of access decisions remaining and each user's review speed, access review system 101 redistributes access decisions that have not been auto rejected or already reviewed (step 406). Access review system 101 may redistribute so faster reviewers receive more access decisions to review than slower reviewers. Access review system 101 may attempt to distribute the remaining access decisions such that the reviewers all finish at roughly the same time.

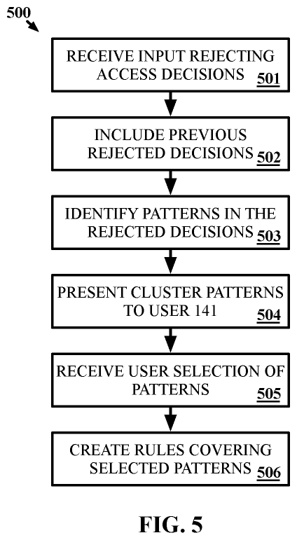

FIG. 5 illustrates operation 500 to automate access review for access decisions responsive to access requests to data environments. In operation 500, access review system 101 receives user input rejecting access decisions (step 501). The user input may be received from a single human user or from multiple human users, such as occurred in operation 400. In some examples, access review system 101 may only consider rejected access decisions by users during one review period for the steps below but, in this example, access review system 101 includes user-rejected access decisions from previous review periods (step 502). For example, access review system 101 may keep a record in database 132 of access decisions rejected by human users during previous review periods.

Access review system 101 processes the rejected decisions to identify one or more patterns within the rejected decisions (step 503). Access review system 101 may use one or more clustering algorithms to identify the patterns by clustering the rejected access decisions. The rejected access decisions may be clustered based on similar resources being requested, similar systems of data environments 102 being accessed, similar users requesting the access, similar paths through privilege graph 131, or based on some other similarity. The algorithms may also output a confidence score for each cluster. The confidence score is an indicator of how similar the rejected decisions in a cluster are to one another. For instance, a higher score may represent clusters that the algorithm(s) determine include more similar rejected decisions, although, other conventions may be used for the score.

In some examples, access review system 101 may automatically create rules from clusters having scores above a predetermined threshold, from a predetermined number of the clusters with the highest scores, or from some other score-dependent selection of the clusters. In this example, access review system 101 presents clusters to user 141 (e.g., an administrator tasked with ensuring based on the clusters' respective confidence scores (step 504). Access review system 101 may present all the clusters, a predetermined number of clusters with the highest scores, all clusters with scores above a predetermined threshold, or some other score-dependent selection of the clusters. When presenting the clusters, access review system 101 may explicitly describe the pattern identified to form the cluster. This ensures user 141 recognizes the pattern for a cluster before deciding whether the pattern should be used to create a rule to auto-reject subsequent access decisions that also fit the pattern.

In this example, user 141 provides input to access review system 101 selecting one or more of the patterns/clusters (step 505). User 141 may only select a subset of the patterns presented by access review system 101. User 141 may base their decisions on whether user 141 thinks all access request decisions that fit the pattern should be rejected. For example, if user 141 thinks an access request decision may occur that fits a presented pattern but should not be auto rejected during review, user 141 may choose not to include that pattern in their selection.

After receiving the user selections, access review system 101 creates rules to cover the selected patterns during auto-rejection (step 506). A rule defines attributes of access decisions (e.g., a requesting user, a requested resource, a decision, a time of day, etc.) that fit a selected pattern. In some examples, a single rule may cover more than one of the selected patterns. The created rules may then be included in the baseline rules used to auto-reject access decisions made during subsequent review periods.

In some examples, the rules used to auto-reject access rules may further be used to modify rules implemented in data environments 102 and user terminal 104 to make access decisions. For instance, if an access-review rule is configured to reject access decisions have certain attributes, then access rules to access resources of data environments 102 may be modified (e.g., rules may be added, removed, or amended) to prevent an access decision from being made that would be rejected by the access-review rules.

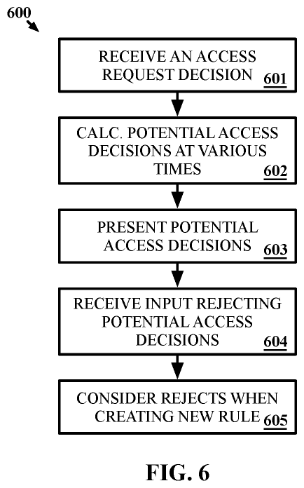

FIG. 6 illustrates operation 600 to automate access review for access decisions responsive to access requests to data environments. In operation 600, access review system 101 receives an access decision (step 601). The access decision may be received in real time as it is made to determine access to a resource requested from a user or may be received by access review system 101 in a batch of access decisions (e.g., upon arrival of a review period). Many access decisions may differ depending on times in which the access requests were made since access rules often include time limitations. For example, certain access requests may only be allowed during certain times of day (e.g., during typical work hours, such as 8 am to 5 pm). As such, access review system 101 uses privilege graph 131 to calculate potential access decisions for the received access decision had the access request occurred at different times (step 602).

Access review system 101 presents the calculated access decisions to user 141 or another reviewing user (step 603). User 141 can then see how the access decision may change for the access request over time. For example, user 141 may be presented with the actual access decision made for the access request at the time when the access request occurred and be presented with receipt times when that access decision would remain the same and times when that access decision would be different. User 141 may then provide input to access review system 101 rejecting certain ones of the potential access decisions (step 604). The rejected potential access decisions may then be considered when creating an access-review rule in addition to user rejections of access reviews described above (step 605). This enables a more comprehensive access review considering potential access decisions that were not actually made. For example, if an access request is allowed during a first time but would not be allowed during a second time. A potential access request being denied during the second time may be presented to user 141 for review. If user 141 indicates denial of that access request during the second time should be a rejected access decision, access review system 101 may create an access-review rule to auto-reject access decisions that deny access requests during the second time.

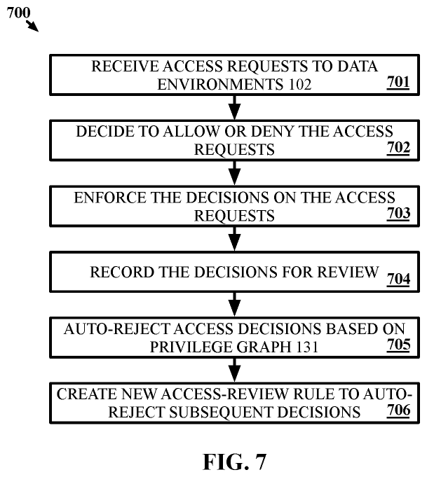

FIG. 7 illustrates operation 700 to automate access review for access decisions responsive to access requests to data environments. In operation 700, access requests are received from access systems 105 (step 701). Specifically, the access requests are received from users (e.g., human users, applications, systems, etc.) and are requesting access to resources (e.g., data sets, applications, processing resources, etc.) supplied by data environments 102. In response to the access requests, data environments 102 determines whether to allow or deny each of the access requests (step 702). The access requests may be received by data environments 102, which may communicate with identity environments 103 to make an access decision (e.g., may check with identity environments 103 to determine whether a user is authorized to access the requested resource). Identity environments 103 may also be used to authenticate the user. Alternatively, the requesting system of access systems 105 may communicate with identity environments 103 to preauthorize the user to access the resource (e.g., may be provided with a secure token) prior to communicating with data environments 102. Other mechanisms for determining whether to allow or deny access requests may also be implemented and may depend on the conventions required by data environments 102 and/or identity environments 103. Likewise, an entity may employ different types of data environments 102 and/or identity environments 103 which causes different conventions to be used for determining whether to allow or deny access requests.

Data environments 102 enforce the access decisions (703). That is, data environments 102 deny access requests that step 702 determines should be denied and allows access requests that step 702 determines should be allowed. Steps 701-703 may occur in real time to ensure there is no appreciable delay when access systems 105 are attempting to access a resource of data environments 102.

Access review system 101 records the decisions made with respect to the access requests (step 704). The decisions may be recorded in database 132. Access review system 101 may receive information about the access decisions (e.g., information describing an access request and indicating the resulting decision) from data environments 102, identity environments 103, access systems 105, or some combination thereof. The information may be received in real time as the decision is happening or the information may be received periodically (e.g., when a review period arrives). Likewise, access review system 101 may request the information or the information may be pushed to access review system 101. Access review system 101 may only keep access decisions recorded for the current review period or may store access decisions for longer, which may depend on whether access decisions from previous review periods (and how many previous review periods) access review system 101 is configured to consider when identifying patterns.

Access review system 101 uses baseline rules from privilege graph 131 and created from previous review periods to automatically reject access decisions from the recorded access decisions (step 705). Access review system 101 also receives input from reviewers (i.e., human users) to reject additional access decisions that were not auto rejected. Access review system 101 then creates one or more new access-review rules to add to the baseline rules for subsequent access review periods (step 706). Access review system 101 may identify patterns in the human-rejected access decisions. A pattern indicates that the current baseline rules were not able to capture and auto-reject access decisions having attributes in the identified pattern. Instead, a human had to reject those decisions. Therefore, access review system 101 may create a new rule to auto-reject subsequent access decisions that conform to the identified pattern, so a human user does not have to reject the decisions during future access-review periods.

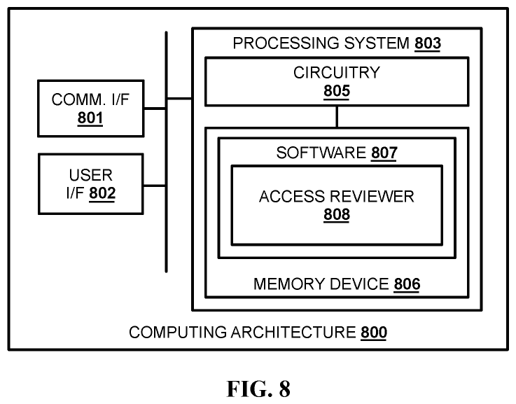

FIG. 8 illustrates computing architecture 800 for automating access review for access decisions responsive to access requests to data environments. Computing architecture 800 is an example computing architecture for access review system 101, although access review system 101 may use alternative configurations. A similar architecture may also be used for other systems described herein (e.g., data environments 102, identity environments 103, user terminal 104, and access systems 105), although alternative configurations for those systems may also be used. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a computer readable storage medium of memory device 806, or any other computer readable storage medium herein, be considered a transitory form of signal transmission (often referred to as “signals per se”), such as a propagating electrical or electromagnetic signal or carrier wave. Operating software 807 comprises computer programs, firmware, or some other form of machine-readable processing instructions. Operating software 807 includes access reviewer 808. Operating software 807 may further include an operating system, utilities, drivers, network interfaces, applications, or some other type of software. When executed by processing circuitry 805, operating software 807 directs processing system 803 to operate computing architecture 800 as described herein.

In particular example, access reviewer 808 directs processing system 803 to obtain access decisions responsive to access requests to a plurality of data environments. Access reviewer 808 directs processing system 803 determine, based on baseline rules, a subset of the access decisions that should be rejected. Access reviewer 808 further directs processing system 803 to receiving user input indicating additional ones of the access requests for inclusion in the subset and determine a new access-review rule based on the user input.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
obtaining access decisions responsive to access requests to a plurality of data environments;
determining, based on baseline rules, a subset of the access decisions that should be rejected;
receiving user input indicating additional ones of the access decisions for inclusion in the subset; and
determining a new access-review rule based on the user input.

2. The method of claim 1, comprising:
enforcing the access decisions on the access requests.

3. The method of claim 1, comprising:
determining at least a portion of the baseline rules from a privilege graph representing data access authorizations to the plurality of data environments.

4. The method of claim 3, wherein determining the subset comprises:
determining an access decision of the access decision does not correspond to a data access authorization indicated in the privilege graph; and
including the access decision in the subset.

5. The method of claim 1, comprising:
dividing the access decisions among users for review; and
receiving the user input from the users.

6. The method of claim 5, wherein dividing the access decisions comprises:
providing a list including a portion of the access decisions to a user of the users, wherein the list identifies each of the access requests by attributes of an access request.

7. The method of claim 6, wherein the attributes include a user making the access request, a resource being requested by the access request, and an indication of whether the access request was allowed or denied.

8. The method of claim 1, comprising:
including the new access-review rule in the baseline rules for a subsequent determination of subsequent access request decisions that should be rejected.

9. The method of claim 1, wherein determining the new access-review rule comprises:
suggesting the new access-review rule to a user; and
receiving user input approving the new access-review rule.

10. The method of claim 1, wherein determining the new access-review rule comprises:
after including the additional ones of the access decisions in the subset, identifying a pattern in the subset; and
creating the new access-review rule to reject subsequent access decisions fitting the pattern.

11. The method of claim 1, wherein determining the new access-review rule comprises:
accessing one or more previous subsets of previous access decisions that should be rejected from previously obtained access decisions;
after including the additional ones of the access decisions in the subset, identifying a pattern in the subset and the one or more previous subsets; and
creating the new access-review rule to reject subsequent access decisions fitting the pattern.

12. The method of claim 11, wherein the pattern is one of a plurality of identified patterns, the method comprising:
suggesting the plurality of identified patterns to a user;
receiving a selection of the pattern from the user; and
creating the new access-review rule in response to the selection.

13. The method of claim 1, comprising:
identifying a second entity having environments similar to a first entity having the plurality of data environments; and
enforcing the new access-review rule for the second entity.

14. The method of claim 1, comprising:
calculating potential access decisions for an access request of the access requests at different timestamps; and
presenting the potential access decisions to a user for review.

15. An apparatus comprising:
one or more computer readable storage media;
a processing system operatively coupled with the one or more computer readable storage media; and
program instructions stored on the one or more computer readable storage media that, when read and executed by the processing system, direct the apparatus to:
obtain access decisions responsive to access requests to a plurality of data environments;
determine, based on baseline rules, a subset of the access decisions that should be rejected;
receive user input indicating additional ones of the access decisions for inclusion in the subset; and
determine a new access-review rule based on the user input.

16. The apparatus of claim 15, wherein the program instructions direct the processing system to:
enforce the access decisions on the access requests.

17. The apparatus of claim 15, wherein the program instructions direct the processing system to:
include the new access-review rule in the baseline rules for a subsequent determination of subsequent access request decisions that should be rejected.

18. The apparatus of claim 15, wherein to determine the new access-review rule, the program instructions direct the processing system to:
access one or more previous subsets of previous access decisions that should be rejected from previously obtained access decisions;
after the additional ones of the access decisions are included in the subset, identify a pattern in the subset and the one or more previous subsets; and
create the new access-review rule to reject subsequent access decisions fitting the pattern.

19. The apparatus of claim 18, wherein the pattern is one of a plurality of identified patterns and wherein the program instructions direct the processing system to:
suggest the plurality of identified patterns to a user;
receive a selection of the pattern from the user; and
create the new access-review rule in response to the selection.

20. A method comprising:
receiving an access request to a plurality of data environments;
making an access decision to allow or deny the access request;
enforcing the access decision on the access request;
recording the access decision in a group of access decisions;
auto rejecting a subset of the group of access decisions based on a privilege graph indicating included access decisions in the subset were incorrect, wherein the privilege graph represents data access authorizations to the plurality of data environments; and
creating a new access-review rule to auto-reject subsequent access decisions made in response to subsequent access requests to the plurality of data environments.
